(19) United States
(12) Patent Application Publication
(10) Pub. No.: US 2001/0052558 A1
(43) Pub. Date: Dec. 20, 2001

(54) Rotary meat grinder with reversible cutter plate

(76) Inventor: Mark S. Younker, Marietta, GA (US)

Correspondence Address: George M. Thomas, THOMAS, KAYDEN, HORSTEMEYER & RISLEY, L.L.P., Suite 1750, 100 Galleria Parkway, N.W., Atlanta, GA, 30339-5948, US

(21) Appl. No.: 09/759,972

(22) Filed: Jan. 12, 2001

Related U.S. Application Data
(60) Provisional application No. 60/176,283, filed on Jan. 14, 2000.

(51) Int. Cl. B02C 18/30

(52) U.S. Cl. 241/82.1

(57) ABSTRACT

The meat grinder 10 comprising an auger housing 16 defining an elongated auger chamber 20 having a delivery end 36, and an auger 22 rotatably mounted in the auger chamber for urging meat toward the delivery end 36 of the auger chamber 20. A support plate 40 is positioned at the delivery end 36 of the auger chamber 20 and defines an array of perforations 44 in communication with the auger chamber. A cutter plate 30 is positioned in the auger chamber 20 in abutment with and is supported by the support plate 40, and defines an array of perforations 38. An alignment lobe 32 protrudes from the cutter plate 30 and registers with a similarly shaped recess 46 in the support plate 40 to align the perforations of the cutter plate 30 with the perforations of the support plate 40. A cutter blade 26 is positioned in the auger chamber 20 and is rotatable in juxtaposition with the cutter plate 30 for cutting meat urged by the auger 22 auger into the perforations 38 of the cutter plate 30. The cutter plate 30 is reversible to present a selected one of two opposed cutting surfaces facing the oncoming meat.

### CROSS-REFERENCE TO RELATED APPLICATIONS

This application claims the benefit of copending U.S. provisional patent application entitled “ROTARY MEAT GRINDER WITH REVERSIBLE CUTTER PLATE” filed on Jan. 14, 2000 and accorded Ser. No. 60/176,283, which is entirely incorporated herein by reference.

### TECHNICAL FIELD

The present invention is generally related to a meat grinder and, more particularly, is concerned with a reversible cutter plate for meat grinders that operates in conjunction with the auger and the rotary cutter blade of the meat grinder to grind meat.

### BACKGROUND OF THE INVENTION

In the past, meat grinders of the general type found in retail markets have a meat receiving chamber with a stationary perforated cutter plate at the delivery end of the chamber and an auger in the chamber. The auger extrudes meat through the perforations of the cutter plate, and a rotary cutter blade rides against the perforated cutter plate and cuts the strands of meat extruded through the perforations of the stationary cutter plate. In some prior art applications, the stationary cutter plate is maintained and supported in position against the rotary cutter blade by a support plate. The rotary cutter blade and the stationary cutter plate of such meat grinders must be replaced or sharpened when they become dull in order to ensure efficient cutting of the meat. When a new or sharpened rotary cutter blade is placed adjacent a worn stationary cutter plate, the worn surfaces of the stationary cutter plate define spaces between the new or sharpened cutting edge of a new rotary cutter blade which affects the cutting efficiency of the meat grinder. Therefore, the stationary cutter plate usually requires resurfacing or replacement simultaneous to sharpening or replacement of the rotary cutter blade.

Two primary styles of cutter plates are incorporated into the predominance of the meat grinders used in the retail markets. The first type of cutter plate is commonly referred to as a hub style cutter plate as it formed with a hub on the side of the cutter plate opposite the rotary cutting blade. Hub style cutter plates are constructed as one-piece, thus requiring a single material to meet the various functions that cutter plates are required to fulfill. Such functions include, for example, supplying a surface suitable to efficient cutting of the meat and providing a plate composition and structure that will tolerate the compacting forces which are generated during meat grinding. Furthermore, although the hub on the hub style cutter plates adds stability, mechanical strength and facilitates easy insertion and removal, the hub also prevents both sides of the hub style cutter plates from being utilized as cutting surfaces. Instead, the hub style cutter plate is removed and resurfaced over and over until the hub plate becomes too thin to use in meat grinding. Because the cutter plates are routinely leased to the meat markets, the removal and resurfacing of the cutter plates requires continual reliance on maintenance personnel. Furthermore, the repeated resurfacings reduce the thickness of the hub style cutter plates, and due to the limited range of cutter plate thickness that the grinders can tolerate, the hub style cutter plates must be thrown away when they become too thin. Accordingly, not only are the hub style cutter plates expensive to maintain, but because of the amount of raw material used in the hub style they are also expensive to manufacture.

The second type of cutter plate is often referred to as a reversible cutter plate due to the fact that both sides of the plate may be used as cutting surfaces. As with the hub style cutter plate, the reversible cutter plate is one-piece construction, and thus a single material is required to meet all of the cutter plate functions. Although two sides of the reversible cutter plates may be used before resurfacing is required, due to the expense of the cutter plates, the reversible plates still require removal and maintenance resurfacing. Often the maintenance costs for removing and resurfacing reversible cutter plates are increased due to the difficulty in removing the reversible cutter plate from the grinder and the fact that two sides of the reversible plate must be resurfaced. Furthermore, since cutter plates are routinely leased to the meat markets, the removal and resurfacing of the cutter plates requires continual reliance on maintenance personnel. Additionally, with repeated resurfacing of both sides of the reversible cutter plates, the cutter plates gradually become too thin for use, requiring replacement. In some instances, reversible cutter plates have been manufactured out of cheap or lower grade material, with the intention that the plates be disposed of, instead of resurfaced, or after becoming too thin from repeated resurfacings. However, the use of lower grade materials decreases the life of the cutter plates and causes increased maintenance due to more frequent cutter plate change outs.

A further problem with prior art stationary cutter plates is that the cutter plates do not have adequate clearance or tolerance in relation to the rotary cutter blade when they are resurfaced or replaced, resulting in excessive wearing of the cutter plates and possible contamination of the meat product with material from the cutter plate or rotary cutter blade.

A further problem with prior art cutter plates utilized in meat grinders is that the cutter plates and support plates do not have, or have only limited, gripping surfaces or apertures that permit an operator to easily remove and replace a cutter plate. Due to the greasy surfaces of the cutter plates during operation, removing and holding a cutter plate during rotary blade changes or cutter plate changes is difficult.

Thus, a heretofore unaddressed need exists in the industry to address the aforementioned deficiencies and inadequacies.

### SUMMARY OF THE INVENTION

The disadvantages of the prior art have been overcome by the present invention that comprises a two-piece construction consisting of a cutter plate and a support plate. The cutter plate is circular and has a pair of opposed parallel cutting surfaces with an array of perforations extending therethrough for defining flow passages for parallel strands of meat to be extruded therethrough in a grinding operation. The cutter plate may be manufactured or utilized to thickness tolerances that were previously considered too thin for prior art cutter plates. Furthermore, because the cutter plate is thin, a better grade of manufacturing materials may be used and still maintain the cost effectiveness of the cutter plates. Thus, the cutter plates are designed to be simultaneously wear resistant and disposable, providing the retail markets with greater flexibility in selecting and using cutter plates which can either be maintained and resurfaced or disposed of cost efficiently.

The cutter plate operates in abutment with a support plate, the support plate having a recessed area and a perimeter holding flange recess for receiving the cutter plate. The support plate imparts mechanical strength and stability to the thin cutter plate. Additionally, since the support plate is not resurfaced, the width of the support plate does not decrease, thus providing a consistent distance for the flow of ground meat to travel and a consistent fit with the meat grinding machine. The opposed parallel cutting surfaces of the cutter plate are adapted to cooperate with a rotary cutter blade and the support plate of the meat grinder. One of the cutting surfaces of the cutter plate is supported against the support plate and the other cutting surface faces the rotary cutter blade and material is urged by the auger into contact with and through the perforations of the support plate and the cutter plate.

Proper operation of each of the opposed, parallel cutting surfaces is insured by aligning means for aligning the array of perforations of the cutter plate with the corresponding array of perforations of the support plate. The preferred embodiment of the aligning means includes a radially protruding lobe on the cutter plate that registers with an identically shaped recessed lobe area extending radially into the perimeter flange of the support plate.

When the cutter blade and/or the facing surface of the cutter plate have become worn and require replacement, the cutter plate can be reversed to have its other surface face the cutter blade. This avoids the necessity of replacing the cutter blade if only the cutter plate surface requires replacement. Also, because of the arrangement of the cutter plate being supported by the support plate, thinner and weaker cutter plates can be employed.

Furthermore, the support plate perforations are chamfered so as to provide adequate clearance or tolerance for the cutter plate in relation to the support plate. This prevents excessive wear of the cutter plate and support plate and prevents contamination of the meat product with material or particles worn away from the cutter or support plates.

Also, the alignment of the perforations of the thin cutter plate with the perforations of the thicker support plate assures that the strands of meat moved through the aligned perforations will maintain a “stringy” or “spaghetti” appearance.

To facilitate cutter plate changes, the support plate is slotted to permit the easy removal of the cutter plate from the recessed area of the support plate. The radially protruding lobes of the cutter plate additionally provide a gripping surface to aid in the removal and changing of rotary blades and cutter plates during grinder operations.

Therefore a primary object of the present invention is to provide a meat grinder having a two-piece cutter plate and support plate combination in which the cutter plate is recessed into and maintained in position by the support plate and in which the cutter plate can be reversed to render a selected one of a pair of opposed parallel cutting surfaces operable in a meat grinding operation.

Another object of the present invention is to provide an improved cutter plate for a meat grinder, the cutter plate having an improved or increased useful plate life while requiring substantially less material to produce.

Another object of the present invention is to allow less costly manufacturing methods to be utilized than those used to manufacture conventional cutter plates. This will be possible owing to the substantial decrease in the thickness and amount of material utilized in producing the cutter plate described herein as opposed to a conventional cutter plate.

Another object of the present invention is to allow a wider array of materials to be used in the manufacture of the thinner cutter plates and the support plate described herein and to provide a maximization of the life to cost ratio of the cutter plates and support plate.

A further object of this invention is to provide a cutter plate that is disposed of after use and deterioration rather than being resurfaced.

Other objects, features and advantages of the present invention will be or become apparent to one with skill in the art upon examination of the following drawings and detailed description. It is intended that all such additional objects, features and advantages be included within this description, be within the scope of the present invention, and be protected by the accompanying claims.

### BRIEF DESCRIPTION OF THE DRAWINGS

The invention can be better understood with reference to the accompanying drawings. The components in the drawings are not necessarily to scale, emphasis instead being placed upon clearly illustrating the principles of the present invention. Moreover, in the drawings, like reference numerals designate corresponding parts throughout the several views.

FIG. 1 is an exploded perspective view of a meat grinder provided with a cutter plate and support plate constructed in accordance with the present invention with a portion of the housing broken away to reveal the auger chamber;

FIG. 2 is a vertical sectional view taken diametrically through the cutter and support plates shown in FIG. 1 and showing the relationship of the cutter plate with the rotary cutting blade; and

FIG. 3 is an enlarged perspective view showing the perforation and aligning means details of the cutter plate and the support plate and the slot access in the perimeter of the support plate. In FIG. 3 the support plate and cutter plate are shown in reverse perspective of their orientation in FIGS. 1 and 2.

### DETAILED DESCRIPTION OF THE PREFERRED EMBODIMENT

Referring now to the drawings, the embodiment chosen for the purpose of illustrating the present invention includes a horizontally oriented meat grinder, represented generally by the reference numeral 10, and an operable power motor means mounted on a base 14, the motor housing 12 carrying a sidewise projecting elongated auger housing 16. A hopper chute 18 having a hollow interior in communication with the interior auger chamber 20 of the auger housing 16 provides a means by which meat can be fed to the grinder at the delivery end 36 of the housing.

Within the elongated auger chamber 20 is a conventional auger 22 that is rotated about its axis by the electric motor in the motor housing 12. The auger 22 urges the meat received through hopper chute 18 forwardly in chamber 20 toward the delivery end 36 of the auger chamber 20. The outer end of the auger 22 is provided with an axially disposed forwardly extending shaft 24 operable for removably receiving a rotary cutter blade 26 supported thereon for rotation with shaft 24 and auger 22. The rotary cutter blade 26 includes four radially extending cutting arms 28 which are adapted to cooperate with a surface of cutter plate 30 embodying the principles of the present invention for cutting meat urged thereagainst by the auger 22.

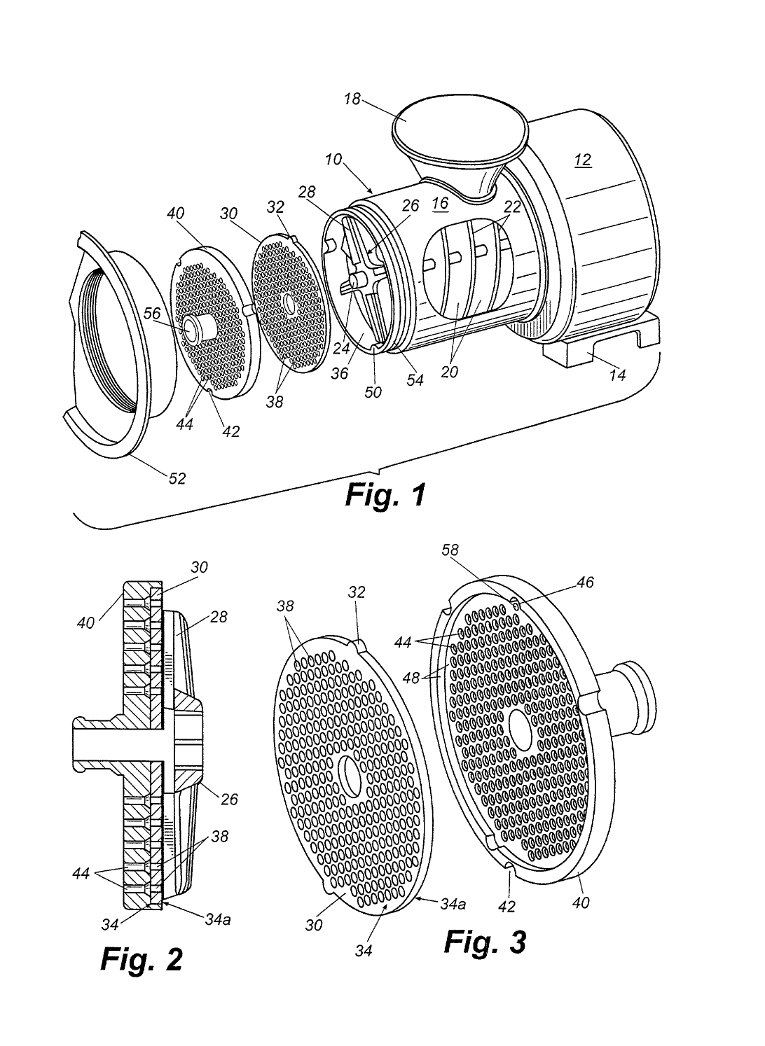

As shown in FIGS. 1-3, the support plate 40 is substantially circular in configuration and includes radially recessed notches 42 formed in the circumference thereof and adapted to register with complementary projections 50 formed on an internal surface of chamber 20 and operable for maintaining the support plate 40 in a non-rotatable position when supported against the rotary cutter blade 26. Support plate 40 has a slot 62 in the exterior perimeter surface thereof adapted for insertion of a device, such as a common screwdriver, to release the cutter plate 30 from the recessed area 48 of the support plate 40. Support plate 40 includes an array of perforations 44 in an axially extending direction.

As shown in FIGS. 1-3, the cutter plate 30 is substantially circular in configuration and includes radially protruding lobes 32 formed on the circumference thereof and adapted to register with identically shaped recessed lobe areas 46 extending radially from the recessed area 48 into the perimeter flange 47 of the support plate 40. The protruding lobes 32 and identically shaped recessed lobe areas 46 allow either surface of the reversible cutting plate 30 to be selected as the cutting surface facing the rotary cutter blade 26 while maintaining the array of perforations 44 of the support plate 40 in alignment with the array of perforations 38 of the cutter plate 30. Aligned arrays of perforations 44 and 38 define material flow passageways which allow cut material to be extruded therethrough in a grinding operation. In the alternative, the lobes can be formed on the support plate and the recesses formed on the cutter plate. Other types of mating protrusions and recesses can be formed to secure the cutting plate relative to the support plate and assist in the removal of the cutter plate from the support plate.

The circular perforations 38 of cutter plate 30 are evenly spaced in radially and angularly extending directions to provide an effective cutting surface adjacent each of the cutter plate surfaces 34 and 34a. Further, the even distribution of perforations 38 will ensure that meat being urged thereagainst in a grinding operation is effectively extruded therethrough to provide a “stringy” or “spaghetti” appearance to the meat.

In an assembled position, a grinding operation is performed by inserting meat to be ground through chute 18 into the interior of chamber 20. The meat inserted into chamber 20 is urged axially therethrough by means of the auger 22 which will urge the meat past the radial arm 28 of rotary cutting blade 26 and against a surface of the cutter plate 30. Meat that is urged against the cutter plate 30 moves into the perforations 38 and 44 of the cutter plate 30 and of the support plate 40, and will be effectively comminuted by rotation of the cutter blade 26 relative to cutter plate 30, with the cutting being performed between the cutting surfaces of the radial arms 28 and the peripheral edges of each of the perforations 38. Meat urged against and into the perforations 38 of the cutter plate 30 and cut by rotary cutter blade 26 will be extruded axially outwardly through aligned perforations 38 and 44 by the force applied to the meat by the auger 22. The perforations 44 of the support plate 40 have chamfered edges 60 on the side of the support plate in abutment with the cutter plate to aid in the extrusion of the meat strands through the aligned perforations 38 and 44 of the cutter plate 30 and the support plate 40.

Should it become necessary to remove the support plate 40 from the meat grinder for any reason, such as replacement or reversal of cutter plate 30, replacement of rotary cutter blade 26, or merely cleaning out the auger chamber 20, collar member 52 is threadably removed from housing threaded portion 54, thereby permitting the support plate 40 to be axially displaced by grasping surface 56.

To facilitate cutter plate 30 reversal or replacement, an axially extending opening 58 has been provided in the radial recessed lobe area 46 of the support plate 40 to assist in separation of the cutter plate 30 from the support plate 40 by passing a suitable tool through perforation 58. Furthermore, the slot 62 is provided in the perimeter flange 47 of the support plate 40 to assist in separation of the cutter plate 30 from the support plate 40 by inserting a suitable tool into the slot 62.

It should be emphasized that the above-described embodiments of the present invention, particularly, any “preferred” embodiments, are only possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A meat grinder adapted to cut meat into small parallel strands of meat, including:
a housing defining an elongated auger chamber having a delivery end,
an auger rotatably mounted in said auger chamber for urging meat toward said delivery end of said auger chamber,
a support plate at said delivery end of said auger chamber, said support plate defining an array of perforations in communication with said auger chamber,
a cutter plate positioned in said auger chamber in abutment with said support plate, said cutter plate defining an array of perforations,
aligning means for aligning the perforations of said cutter plate with the perforations of said support plate, and
a cutter blade in said auger chamber and rotatable in juxtaposition with said cutter plate for cutting meat extending from said auger chamber into said cutter plate.

2. The meat grinder of claim 1, wherein the support plate perforations are chamfered on the side adjacent to the cutter plate.

3. In a meat grinder adapted to cut meat into parallel strands of meat, comprising:
a support plate defining an array of perforations for passage of strands of meat, the improvement therein comprising:
a cutter plate sized and shaped for abutting said support plate,
said cutter plate defining an array of perforations sized and positioned for alignment with the perforations of said support plate and for the passage of meat therethrough, and
aligning means formed on said cutter plate and arranged to align said cutter plate with said support plate so that said perforations of said cutter plate become aligned with said perforations of said support plate.

4. The meat grinder of claim 3, wherein the cutter plate is constructed of a metal material.

5. The meat grinder of claim 3, wherein the cutter plate is constructed of a plastic material.

6. The meat grinder of claim 3, wherein the cutter plate is constructed of a composite material.

7. The meat grinder of claim 3, wherein the support plate is constructed of a metal material.

8. The meat grinder of claim 3, wherein the support plate is constructed of a plastic material.

9. The meat grinder of claim 3, wherein the support plate is constructed of a composite material.

10. The meat grinder of claim 3, wherein:
said cutter plate has opposed parallel cutting surfaces, and
said cutter plate is sized and shaped so that either of its opposed parallel cutting surfaces can be placed in abatement with said support plate.

11. The meat grinder of claim 3, wherein the perforations of said support plate are of larger breadth than the perforations of said cutter plate.

12. The meat grinder of claim 3, and further including:
a rotary cutter blade positioned in abatement with said cutter plate,
an auger for urging meat toward said cutter plate, and
a motor for rotating said auger and said rotary cutter blade.

13. A meat grinder, having a housing defining an elongated auger chamber with a delivery end, an auger rotatably mounted in said auger chamber for urging meat toward the delivery end of the auger chamber, a support plate at the delivery end of said auger chamber defining an array of perforations therethrough for the passage of ground meat, and a rotary blade adjacent said support plate for cutting meat moving toward the support plate, the improvement therein comprising:
a cutter plate for placement in abutment with said support plate between the support plate and the rotary cutter, said cutter plate comprising:
parallel opposed surfaces,
an array of perforations formed therethrough sized and shaped to align with the perforations of said support plate, said perforations forming cutting edges at said opposed surfaces,
aligning means formed on said cutter plate for mounting said cutter plate with its perforations in alignment with the perforations of the support plate,
said aligning means being formed to align said perforations of said cutter plate with the perforations of said support plate when said cutter plate has either of its cutting surfaces facing the support plate.

14. The meat grinder of claim 13, wherein said support plate has a surface facing said cutter plate and said perforations of said support plate at said surface facing said cutter plate are of greater breadth than the breadth of the perforations of said cutter plate.

15. A method of grinding meat comprising the steps of:
(a) urging meat along an auger chamber in response to rotary movement of an auger in sequence through the perforations of a cutter plate and a support plate with the perforations of the plates aligned with one another, and the perforations of the cutter plate forming cutting edges on both surfaces of the cutter plate,
(b) cutting the meat into strands of meat as the meat enters the perforations of the cutter plate, and
(c) supporting and maintaining the direction of movement of each stream of meat moving from the perforations of the cutter plate with the perforations of said support plate,
(d) when the cutting edges of a side of the cutter plate become dull, turning the cutter plate to place its opposing side to face the oncoming meat, and
(e) repeating steps a, b and c, and
(f) when both sides of the cutter plate become dull, replacing the cutter plate with a duplicate cutter plate.

16. A meat grinder of the type having a housing defining an auger chamber and a discharge end, a rotatable auger positioned in the auger chamber for urging meat in the chamber toward the discharge end of the chamber, a support plate positioned at the discharge end and defining an array of perforations therethrough for the passage of meat urged by the auger, and a rotary cutter blade positioned to cut meat moving into the perforations, a cutter plate for placement in the auger chamber in abutment with the support plate and for cutting meat urged by the auger toward the support plate, said cutter plate comprising:
opposed parallel cutting surfaces;
an array of perforations extending through said cutter plate and forming cutting edges at said opposed cutting surfaces of said cutter plate, said perforations positioned to register with the perforations of the support plate when either of the cutting surfaces of said cutter plate faces the support plate, and
alignment means formed on said cutter plate and positioned to register with a complementary shaped alignment element of the support plate to orient said cutter plate such that said perforations of said cutter plate align with the perforations of the support plate when either cutting surface of said cutter plate faces the support plate.

17. The meat grinder of claim 16, wherein said cutter plate is substantially circular in shape.

18. The meat grinder of claim 16, wherein said cutter plate is reversible to present a selected one of two opposed cutting surfaces facing meat urged by said auger toward said support plate.

19. The meat grinder of claim 16, wherein said alignment means of said cutter plate comprise lobes extending radially from said cutter plate and maintain said cutter plate in a non-rotatable position relative to said rotary cutter blade and said support plate.

20. The meat grinder of claim 16, wherein said support plate is substantially circular in shape and comprises radially recessed notches formed in the circumference thereof which maintain the support plate in a non-rotatable position relative to said auger chamber and said discharge end.

21. The meat grinder of claim 16, wherein said support plate is defined by an opening in said radially recessed lobe notches and by a slot in a perimeter holding flange of said support plate.

22. The meat grinder of claim 16, wherein said cutter plate is removable from said support plate by insertion of a tool through said opening and by insertion of a tool through said slot.

23. A cutter plate and support plate system for use in grinders, comprising:
a cutter plate defining opposed cutting surfaces, said cutter plate adapted to be reversibly mounted within a grinder wherein one of said cutting surfaces of said cutter plate is adjacent to a rotary cutter blade
said cutter plate being formed with an array of perforations extending therethrough for defining passageways for ground material to be extruded therethrough and wherein the edges about said perforations define cutting surfaces adapted to cooperate with said rotary blade to grind material,
said cutter plate having a plurality of protruding lobes formed on the circumference thereof,
a support plate having a plurality of recessed lobe areas extending radially from a recessed area to a perimeter flange of said support plate,
said protruding lobes of said cutter plate adapted to register with said recessed lobe areas of said support plate, and
said recessed area of said support plate being sized to accept said cutter plate into said recessed area such that said cutter plate is maintained in substantially non-rotatable position between support plate and said rotary cutter blade.

24. The system of claim 1, wherein said cutter plate is removably and reversibly engaged between said support plate and said rotary cutter blade.

25. The system of claim 1, wherein said cutter plate is removably and reversibly engaged between said support plate and said rotary cutter blade.
